(19) United States
(12) Patent Application Publication
(10) Pub. No.: US 2007/0157518 A1
(43) Pub. Date: Jul. 12, 2007

(54) Power-operated door opening and closing system

(76) Inventors: Lorenzo Galberti, Musile di Piave (IT); Simone Trentin, Zenson di Piave (IT)

Correspondence Address: WENDEROTH, LIND & PONACK, L.L.P., 2033 K STREET N. W., SUITE 800, WASHINGTON, DC, 20006-1021, US

(21) Appl. No.: 10/582,947

(22) PCT Filed: Dec. 13, 2004
(86) PCT No.: PCT/EP04/14142

§ 371 Date: Jun. 15, 2006

(30) Foreign Application Priority Data
Dec. 17, 2003 (IT) MI2003U000597

(51) Int. Cl. E05F 15/10

(52) U.S. Cl. 49/26

(57) ABSTRACT

The power-operated door opening and closing system (10) of the present invention is of the kind adapted to be attached to the ceiling and comprises: an electric motor, an electric motor control unit, an electric push-button (P) actuating switch to control the motor operation, a string (30) or the like, and a mechanism adapted to convert the pulling of the string into a pressure upon the push-button switch or a pull of the pull-type switch.

The present invention refers to a power-operated drive system for opening and closing main doors.

Up to just a few years ago, gates, main entrance doors, garage doors and the like used in the majority of cases to be operated, i.e. opened and closed manually, while automatic, motor-driven opening and closing systems were invariably considered luxury items.

In the course of these last few years, especially in more affluent countries, automatic power-operated door closing and opening systems have gradually become more popular and increasingly high in demand on the marketplace. These automatic power-operated door opening and closing systems are based on and imply the use of one or more electric motors.

When a new house is being built, it is quite easy and convenient for such power-operated automatic door opening and closing systems to be installed, since this in general involves just a small, simple electric installation to be provided for controlling and ensuring the power supply to the electric motor forming the drive unit of the system. In the simplest case, such electric installation is constituted by just two electric wires and a switch.

When a system is on the contrary to be installed in an existing building, this requires not only the drive motor to be duly installed, but also the related electrical installation to be provided. To do this, the need arises for the required electrical installation to be either allowed to run outside the walls (but this is certainly not aesthetically appealing) or be built-in, i.e. allowed to run inside the walls (which must therefore be first broken down and then re-built and fixed up again by a mason); in any case, it is necessary to have an electrical contractor doing the related job, since currently applicable safety regulations require that electrical installations be solely completed by a skilled electrician. As a result, and just on the same reasons connected to the applying safety regulations on electric installations, users are not even supposed to install the drive motor of such systems by their own.

A solution to such problem lies in buying “self-contained” powered door opening and closing systems based on the use of a remote radio-frequency control. In this case, in fact, the remote control controls the movement of the door by radio signals, so that no electrical control installation is needed, actually. It should however be considered that the cost of these systems is of course much higher.

Powered door opening and closing systems for garage doors of the horizontally pivoting, sectional or vertically pivoting type are currently available on the market, which are provided with a push-button located on the system's casing to control the operation of the electric motor of the same system. The latter is generally mounted on to the ceiling, so that it actually proves rather difficult for said push-button to be conveniently reached. As a matter of fact, this push-button is generally intended for use to either installation testing purposes or as an emergency provision.

It is therefore the object of the present invention to provide a solution that, while being simple and low in costs, does fully away with the afore-indicated drawbacks.

The innovative concept, which the present invention is based on, consists in making use of a string, or a similar contrivance, which enables the operation of the drive motor of the powered door opening and closing system to be controlled by pulling it. According to the present invention, the drive unit of the powered door opening and closing system comprises an electric push-button control switch or a pull-type control switch, whereas, through an appropriate mechanism, the pull imparted to the string is converted into a pressure acting on said push-button or a pulling force acting on said pull-type control switch.

The inherent effectiveness, simplicity and low-cost character of this solution are fully appreciable. Furthermore, the inventive solution itself is quite convenient to use even in conjunction with powered door opening and closing systems based on radio-frequency remote control concepts. In fact, the related RF remote control is usually kept in the car, and is often used as an appendage to the key-holder carrying the car-starting key. It now often occurs that, for any reason whatsoever, people come to be in a garage and the car is not parked there, or the keys thereof (with the related key-holder) are not available, while the garage door has to be opened anyway. With the solution according to the present invention, pulling the string is all it takes to cause the garage door to move into opening.

According to a preferred aspect of the present invention, the system is provided with both an indirect drive control feature by means of a string and a direct drive control feature by means of a proper device situated on the casing accommodating the drive motor.

Features and advantages of the present invention will anyway be more readily understood from the description that is given below by way of non-limiting example with reference to the accompanying drawings, in which:

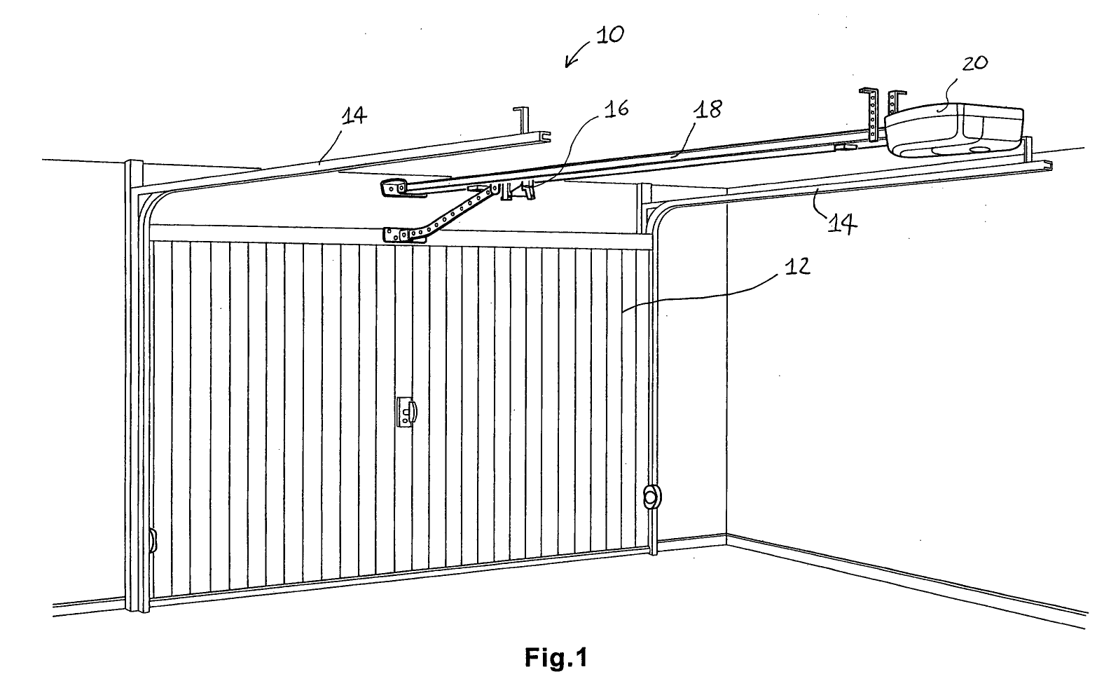

FIG. 1 is an overall view of an electrically powered door opening and closing system according to the prior art;

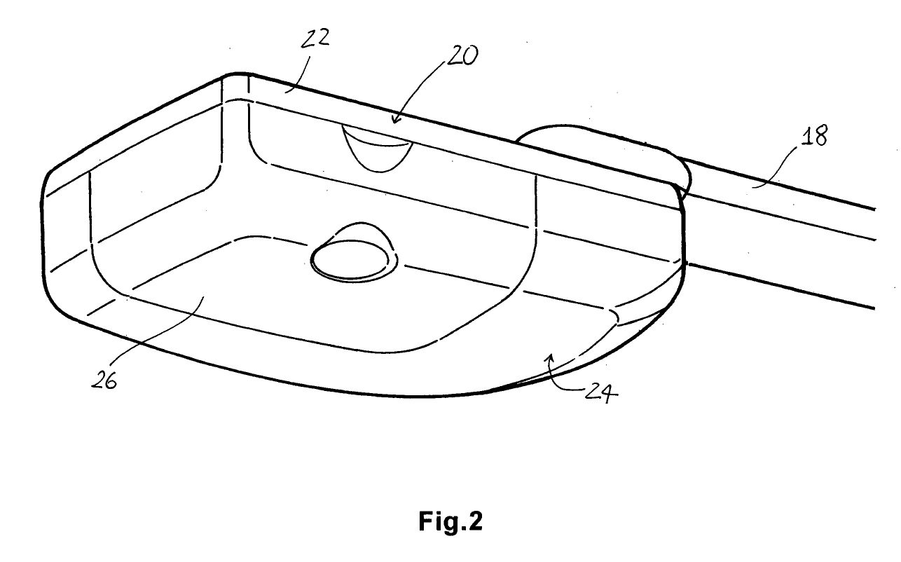

FIG. 2 is an enlarged view of the system illustrated in FIG. 1;

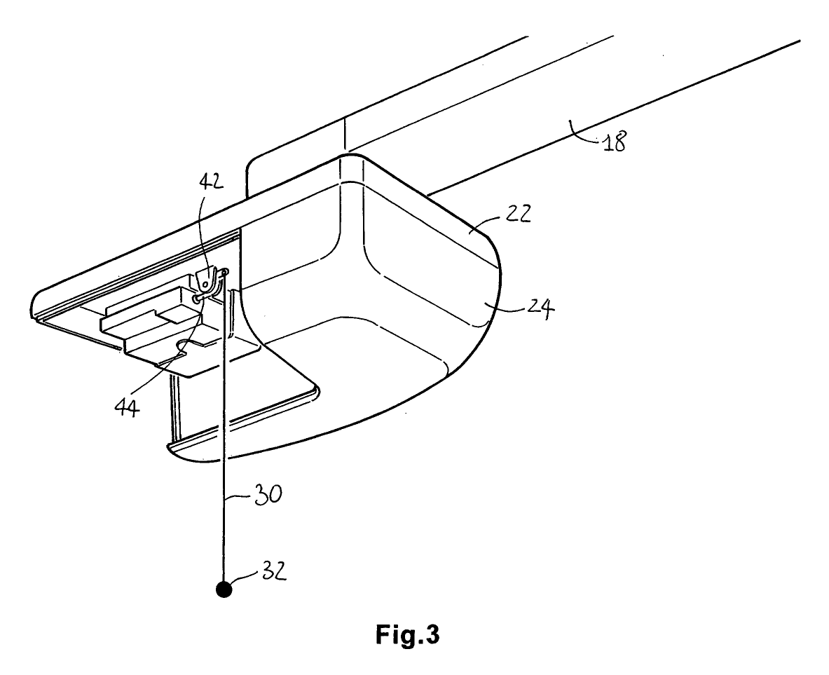

FIG. 3 is a view of a first embodiment of the electrically powered door opening and closing system according to the present invention;

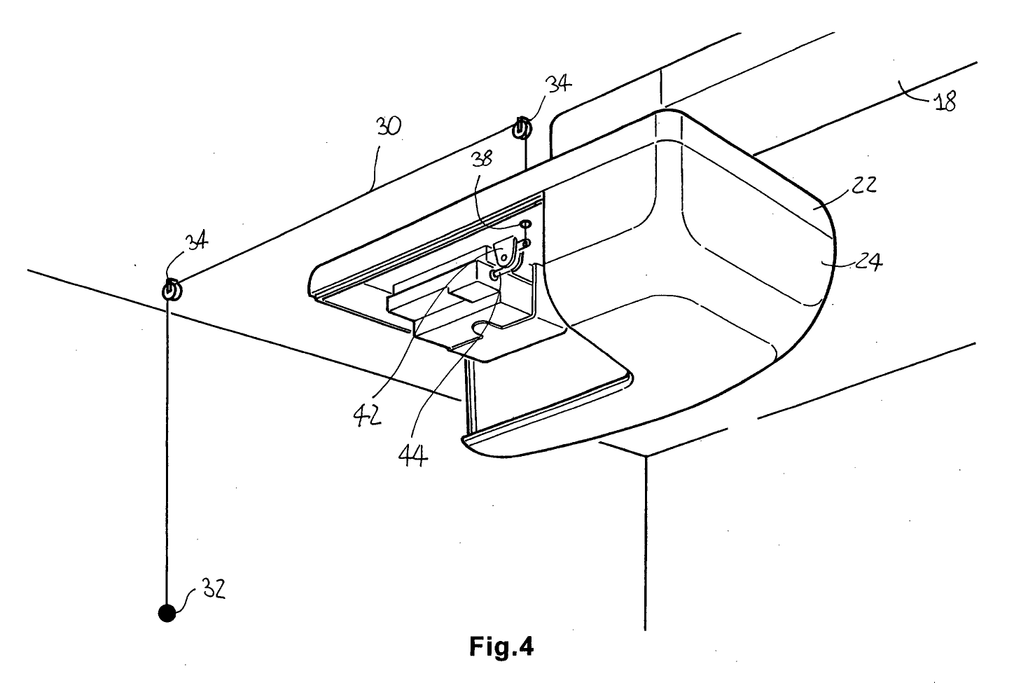

FIG. 4 is a view of a second embodiment of the electrically powered door opening and closing system according to the present invention;

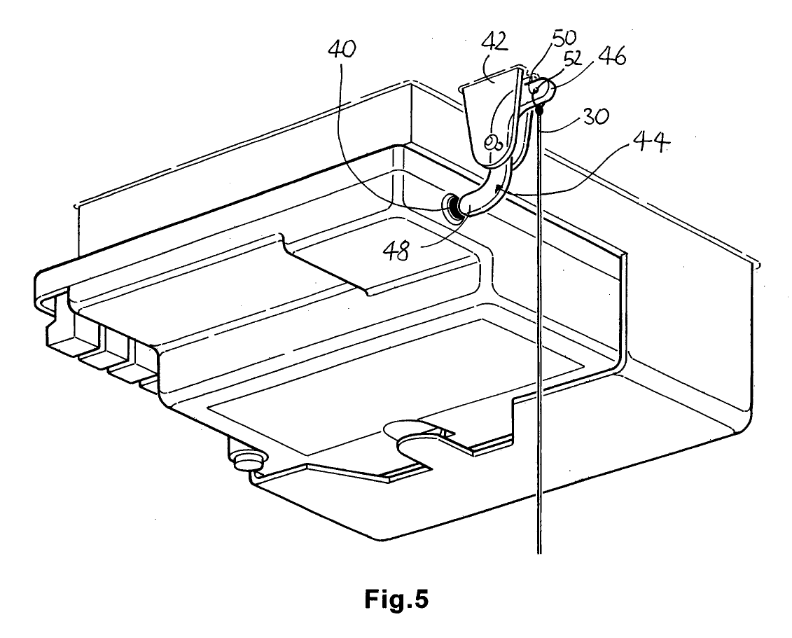

FIG. 5 is a view of a detail of a third embodiment of the electrically powered door opening and closing system according to the present invention;

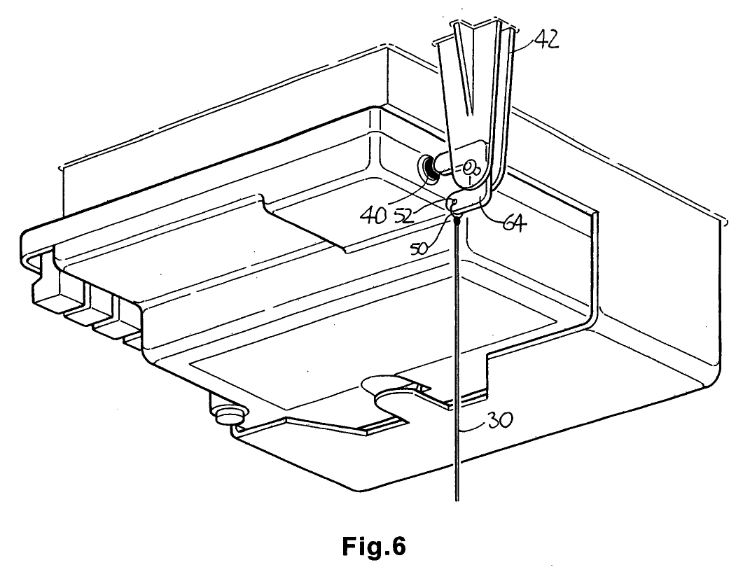

FIG. 6 is a view of a detail of a fourth embodiment of the electrically powered door opening and closing system according to the present invention;

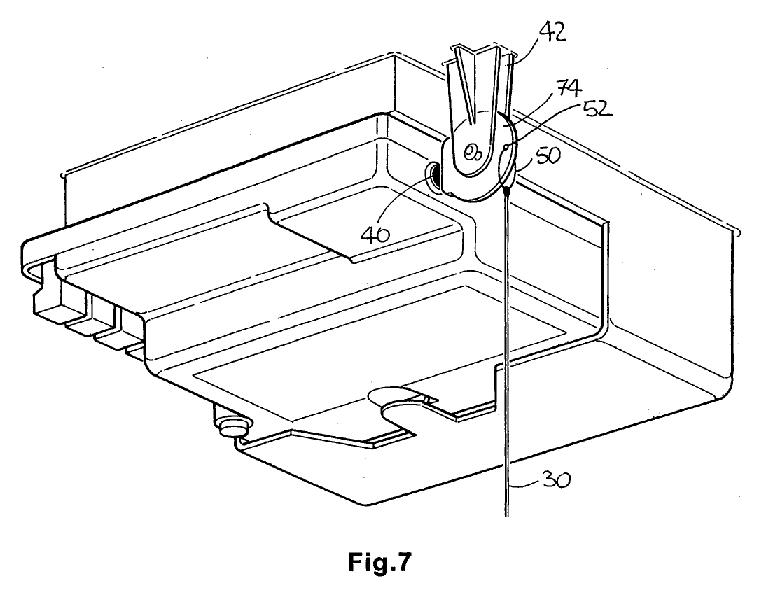

FIG. 7 is a view of a detail of a fifth embodiment of the electrically powered door opening and closing system according to the present invention; and

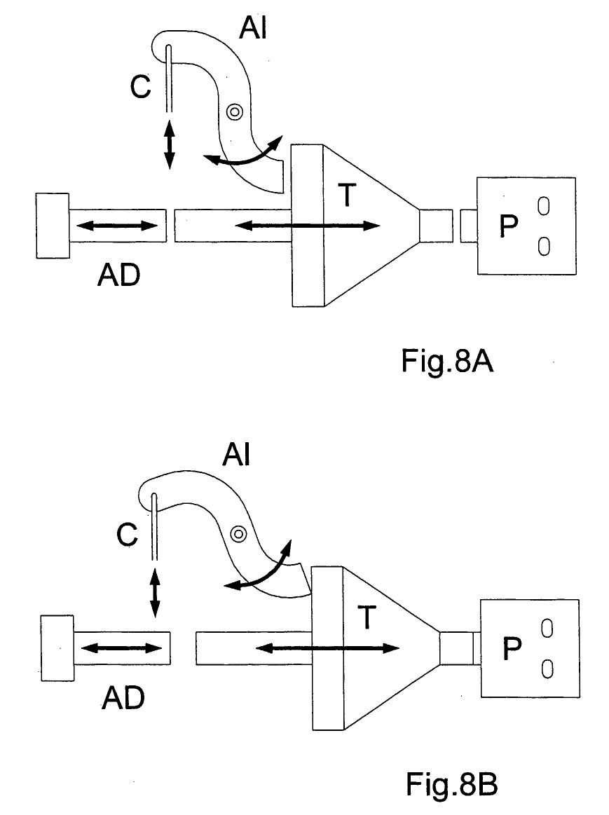

FIG. 8 is a schematical view illustrating the operation of a particular example of embodiment of the mechanism according to the present invention.

With reference to FIG. 1, the same can be noticed to illustrate an electrically powered door opening and closing system 10 according to the prior art as installed in a garage and applied to a garage door 12 of the so-called sectional type, wherein the system itself is operated by radio-frequency remote control. The system is ceiling-mounted, namely applied to the ceiling at a distance of approx. 20 cm therefrom; the inner height of the garage is approx. 250 cm; the height of the door 12 is approx. 210 cm. The door 12 itself slides along two fixed side runners 14; a rod is hinged on, at a first end thereof, to the upper portion of the door at the centre thereof, whereas at a second end thereof it is hinged on to a carriage 16. This carriage 16 slides along a central runner 18 and is driven by a chain extending inside the runner 18. The chain is in turn driven (i.e. pulled and pushed) by the electric motor of the door opening and closing system.

FIG. 2 is an enlarged view of the electrically powered door opening and closing system 10 illustrated in FIG. 1. More particuarly, FIG. 2 illustrates a closed casing 20 accommodating the system itself, along with a part of the closed runner. The casing 20 is comprised of an upper shell 22 and a lower shell 24, and is further provided with an access lid 26 provided in the lower shell 24 thereof, said lid 26 being removable in order to enable access to be gained to the component parts of the system accommodated inside the casing, including an electric motor control unit generally referred to also as “central control unit”.

The electrically powered door opening and closing system 10 described with reference to FIGS. 1 and 2 is well known in the art and largely available on the market, so that no need arises here for it to be described and explained any further.

The innovative concept, which the present invention is based on, consists in making use of a string 30, or a similar contrivance, which enables the operation of the drive motor of the electrically powered door opening and closing system to be controlled by pulling it.

The electrically powered door opening and closing system according to the present invention is of the type suitable for use in connection with large doors in general, as well as for ceiling-mounting.

In the case that an electric control push-button is used, the system according to the present invention comprises:

a) an electric drive motor,

b) an electric motor control unit,

c) an electric push-button to control motor operation,

d) a string or similar contrivance,

e) a mechanism adapted to convert the pulling of the string into a pressure upon the push-button.

In the case that a pull-type control switch is used, the system according to the present invention comprises:

a) an electric drive motor,

b) an electric motor control unit,

c) an electric pull-type control switch to control motor operation,

d) a string or similar contrivance,

e) a mechanism adapted to convert the pulling of the string into a pulling action of the pull-type control switch.

A chain or a small cord may for instance be used instead of the above-mentioned string, wherein this pulling member may be made of plastics or metal. For instance, at an end portion of this pulling member there can be advantageously provided a proper handgrip, ball grip, i.e. something to make it easier and convenient for a user to grasp the pulling member and pull it.

The length of such string shall be selected so as to enable a user, i.e. an adult person, to grasp and pull it conveniently. The ball grip shall preferably hang or, anyway, be situated at a height ranging from 175 cm to 200 cm from the floor, so as to be able to be grasped by an adult, man or woman, by raising an arm, while proving unreachable to children.

In the illustrations appearing in FIGS. 3 and 4, the string 30 is clearly visible, whereas the mechanism is just vaguely outlined. In both examples shown in these Figures, the string ends in a ball grip 32.

In FIGS. 3 and 4, the lid 26 has been removed from the casing 20 enclosing the system, so as to enable the arrangement of the system's parts, including the electric motor control unit (although scarcely visible in the same Figures), inside the casing 20 to be better viewed. Shown in these Figures there is also a part of the runner 18, in which the member used to drive the door into moving, such as for instance a chain or a cord, is able to slide as driven by the electric motor of the electrically powered door opening and closing system 10.

The electric motor control unit may be embodied in a number of different manners; in the simplest one of these manners, it may be constituted by just a relay, whereas, in the most complex one, it may for instance be comprised of a programmed computer and a radio receiver. Obviously, the control switch-button, or pull-type switch, as the case may be, is connected electrically with this motor control unit; in the examples illustrated in the Figures, the control switch-button, or pull-type switch, as the case may be, is located on the same control unit. Anyway, all these types of motor control units are largely known in the art and readily available on the market.

The way in which the electrically powered door opening and closing system according to the present invention operates is similar to the one of some prior-art electrically powered door opening and closing systems. Typically, if the string is pulled a first time, the motor is started and caused to rotate in a first direction of rotation; if the string is pulled a second time, the motor is stopped; if the string is pulled a third time, the motor is started and caused to rotate in a second direction of rotation, which is opposite to the first one; if the string is pulled a fourth time, the motor is stopped; and so on.

In the example illustrated in FIG. 3, the string 30 descends perpendicularly from the system's casing 20 and, more particularly, under the driving mechanism. The casing 20 is provided with an aperture (not shown in FIG. 3) for the string to be able to pass and slide therethrough; in the example illustrated in FIG. 3, such aperture is provided in the lid.

In the example illustrated in FIG. 4, there is provided a wall-mounted or, more particularly, a ceiling-mounted path inverting loop for the string 30; in alternative examples, such path inverting loop for the string 30 might be attached to the casing of the drive system itself In the example shown in FIG. 4, the path inverting loop for the string is constituted by two small swivel pulleys 34, although use might be made of fixed-pin pulleys in other examples of embodiment.

For instance, the use of such path inverting loop for the string 30 may prove advantageous whenever the drive unit of the door operating system 10 is installed at a central zone in the car parking area in the garage, so that, when the car is in the garage, it proves difficult to grasp and pull the string, if the latter is provided to descend perpendicularly under the casing of said drive unit: through the use of a path inverting loop, the string 30 can therefore be caused to descend where it is most convenient to be grasped and pulled.

Even in the case that a string path inverting loop is used, the casing 20 is provided with an aperture 38 to allow the string to pass and slide therethrough; in the example illustrated in FIG. 4, the aperture 38 (clearly visible in FIG. 4) is provided in the upper shell 22 of the casing.

In view of enabling it, and the system, to more effectively withstand the effects of possible excessive pulling forces, it may be contemplated to provide the string 30 with a certain elasticity.

As an alternative option, and for this same reason, it may be contemplated that at least an elastic element, such as for instance a simple helical spring, be provided somewhere along the string. In this case, such elastic element might be provided either at an end portion of the string or in an intermediate position thereof; most advantageously, such elastic element is provided at each one of the end portions of the string. If at least one such elastic element is used, the string itself can be perfectly rigid.

In order to more effectively prevent the door operating system, and more particularly the transmission mechanism and/or the control push-button/pull-type switch, from suffering damages in the case of an excessive pulling force being applied to the string, the use may be contemplated of a release arrangement adapted to release, i.e. disengage the string whenever the pulling force applied to the string itself exceeds a pre-set value.

FIGS. 5, 6 and 7 schematically illustrate three different types of transmission mechanisms; as it can most clearly be noticed, these Figures are merely illustrative sketches and shall therefore not be intended as being real technical drawings. In any case, each one of these three transmission mechanisms is adapted to convert the pulling force applied to the string 30 into a pressure exerted on the push-button 40. Fully visible in these Figures is also the electric motor control unit of the drive system, with the push-button 40 shown intentionally in black.

The mechanisms shown in these Figures are most simply comprised of a support member 42, on which there is hinged a lever member 44; the string 30 is coupled to an end portion 46 of said lever member 44, whereas the opposite end portion 48 of said lever member 44 is capable of acting upon the push-button 40: when a pulling force is applied to the lever member 44 via the string 30, the same lever member 44 is caused to rotate, thereby moving into pushing the push-button 40.

In these Figures, the string 30 is attached to the lever member 44 by means of a ring 50 inserted in a small hole 52 provided at an end portion 46 of said lever member 44. The lever member 44 illustrated in FIG. 5 is in the shape of an “S”, whereas the lever member 64 illustrated in FIG. 6 is in the shape of a U. The lever member 74 illustrated in FIG. 7 is in the shape of a cut circle. It will of course be appreciated that the lever member itself may be given any other shape as far as this is effective in enabling it to perform in the intended manner.

The arms of the lever member may advantageously be differently long, i.e. have a different length, so that to a displacement in the order of a few centimetres (which may vary from 1 cm to 6 cm, for example) of the string there corresponds a displacement by just a few millimetres (which may vary from 1 mm to 3 mm, for example) of the push-button.

Some particularly advantageous features of the transmission mechanism according to the present invention, although not shown or particularly highlighted in FIGS. 5, 6 and 7, shall be described below.

The mechanism itself may be designed so as to define a sliding displacement path for the string 30. In this case, there will be provided mechanical elements to act as displacement limit, so that any excessive pulling force applied to the string is positively prevented from being able to damage the push-button or the pull-type control switch. The displacement path of the mechanism may be such as to contemplate a resting position of the string corresponding to one of the end limits of the same displacement path.

The mechanism may include a device adapted to cause the string to slide back into the resting position thereof when the same string is not actuated; typically, such device would be constituted by a normal spring; in the examples shown in the above-cited Figures, this spring could be arranged so as to act upon the lever member.

Following advantageous features of the transmission mechanism according to the present invention can be more readily understood by referring to the illustration in FIG. 8, although such reference should not be intended as having any limitative purport.

FIG. 8 can be noticed to schematically illustrate a transmission mechanism in two different situations, i.e. states thereof: FIG. 8A illustrates the case in which the string is not being pulled, while FIG. 8B illustrates the case in which the string is being fully pulled.

In FIG. 8, a push-button is indicated at P, a string is indicated at C, an indirect actuation member (a lever member in the Figure) is indicated at AI, a direct actuation member (a push-button in the Figure) is indicated at AD, and a transmission member is indicated at T. If the member AD is actuated, this is caused to displace to the right, thereby pushing the member T, which in turn pushes the button of the push-button switch P. If the string C is pulled, the member AI rotates, thereby pushing the member T, which in turn pushes the button of the push-button switch P, as this is shown in FIG. 8B.

The transmission mechanism according to the present invention may therefore advantageously comprise a direct actuation member adapted to be actuated directly by the user so as to cause a pressure to be applied on to the push-button switch or a pulling force to be applied to the pull-type control switch.

In addition, the transmission mechanism according to the present invention may therefore advantageously comprise an indirect actuation member connected to the string and a transmission member adapted to be displaced by both the direct actuation member and the indirect actuation member and pass on this displacement to the push-button or pull-type switch.

In this manner, the drive unit of the electrically powered door opening and closing system according to the present invention can be provided with both a motor-operation control string and a motor-operation control button, wherein the button may advantageously by situated on the system's casing, while the string can be only installed if the user really needs it.

As an alternative option to a transmission member adapted to be displaced by both the direct actuation member and the indirect actuation member, use can be made of a second push-button or pull-type control switch, wherein the first push-button or pull-type control switch is adapted to be actuated indirectly via the string and the second push-button is located on the system's casing for direct actuation by the user. The first such push-button and the second one are connected electrically in parallel.

1. Power operated door opening and closing system (10) of the type adapted to be mounted to a ceiling, comprising:
a) an electric drive motor,
b) an electric motor control unit,
c) an electric push-button switch (40) to control motor operation,
d) a string (30) or similar contrivance,
e) a mechanism (42, 44; 42, 64; 42, 74) adapted to convert the pulling of the string (30) into a pressure upon the push-button switch (40).

2. Power operated door opening and closing system (10) of the type adapted to be mounted to a ceiling, comprising:
a) an electric drive motor,
b) an electric motor control unit,
a) an electric pull-type control switch (40) to control motor operation,
c) a string (30) or similar contrivance,
d) a mechanism adapted to convert the pulling of the string into a pulling action of the pull-type control switch.

3. System (10) according to claim 1, wherein said string (30) is provided with a certain elasticity.

4. System (10) according to claim 1, wherein at least an elastic member is provided along said string (30).

5. System (10) according to claim 1, wherein said mechanism defines a displacement of said string (30).

6. System (10) according to claim 5, wherein said displacement includes a resting position of the string (30) corresponding to one of the ends of the displacement path.

7. System (10) according to claim 6, wherein said mechanism includes a device adapted to cause the string to slide back into the resting position thereof when the same string is not actuated.

8. System (10) according to claim 1, wherein there is provided a string path inverting loop for mounting to the system's casing (20), a wall or a ceiling.

9. System (10) according to claim 1, in which said mechanism includes a direct actuation member (AD) adapted to be actuated directly by a user so as to cause a pressure to be applied on to the push-button switch (P) or a pulling force to be applied to the pull-type control switch.

10. System (10) according to claim 9, wherein said mechanism includes an indirect actuation member (AI) connected to the string (C) and a transmission member (T) adapted to receive a displacement motion by both said direct actuation member (AD) and said indirect actuation member (AI) and pass on this displacement to the push-button or pull-type switch (P).

11. System according to claim 1, comprising a further electric push-button switch connected in parallel to said push-button or pull-type switch and located on the system's casing.

12. System (10) according to claim 2, wherein said string (30) is provided with a certain elasticity.

13. System (10) according to claim 2, wherein at least an elastic member is provided along said string (30).

14. System (10) according to claim 2, wherein said mechanism defines a displacement of said string (30).

15. System (10) according to claim 14, wherein said displacement includes a resting position of the string (30) corresponding to one of the ends of the displacement path.

16. System (10) according to claim 15, wherein said mechanism includes a device adapted to cause the string to slide back into the resting position thereof when the same string is not actuated.

17. System (10) according to claim 2, wherein there is provided a string path inverting loop for mounting to the system's casing (20), a wall or a ceiling.

18. System (10) according to claim 2, in which said mechanism includes a direct actuation member (AD) adapted to be actuated directly by a user so as to cause a pressure to be applied on to the push-button switch (P) or a pulling force to be applied to the pull-type control switch.

19. System (10) according to claim 18, wherein said mechanism includes an indirect actuation member (AI) connected to the string (C) and a transmission member (T) adapted to receive a displacement motion by both said direct actuation member (AD) and said indirect actuation member (AI) and pass on this displacement to the push-button or pull-type switch (P).

20. System according to claim 2, comprising a further electric push-button switch connected in parallel to said push-button or pull-type switch and located on the system's casing.
